(19) United States
(12) Patent Application Publication
(10) Pub. No.: US 2010/0238759 A1
(43) Pub. Date: Sep. 23, 2010

(54) DEVICE AND METHOD FOR PROCESSING OF POLYMER MATERIALS

(75) Inventor: Tim Carsten Pohl, Hannover (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: TROESTER GMBH & CO. KG, Hannover (DE)

(21) Appl. No.: 12/740,429

(22) PCT Filed: Aug. 18, 2008
(86) PCT No.: PCT/DE08/01341

§ 371 Date: Apr. 29, 2010

(30) Foreign Application Priority Data
Oct. 29, 2007 (DE) 10 2007 051 923.2

(51) Int. Cl. B01F 7/08

(52) U.S. Cl. 366/81; 366/84

(57) ABSTRACT

A device for processing a polymer material including a first screw having a first length; and a second screw having a second length different from the first length, wherein the first screw is configured to be rotated at one of a direction and a speed of rotation that is independent from a respective speed or rotation of the second screw.

This application is a U.S. National Phase application under 35 U.S.C. §371 of International Application No. PCT/DE2008/001341, filed Aug. 18, 2008 and claims benefit to German Application No. DE 10 2007 051 923.2, filed Oct. 29, 2007. The International Application was published in German on May 7, 2009 as WO 2009/056083 under PCT Article 21 (2).

The invention relates to a device, in particular in the form of an extruder, and a method for processing polymer materials, in particular rubber, having a first screw and a second screw, the two screws having different lengths.

### BACKGROUND

Such a device is used for the continuous processing of rubbers and thereby performs plastification work. Plastification takes place by separation and distribution of the mixture. The dissipation introduced thereby must not lead to permissible temperature values being exceeded. A plastified rubber mixture is required in order to achieve uniform moulding in the extrusion head.

In the case of mixtures comprising a natural rubber component, additional shear energy is also required in order to obtain a more uniform chemical structure (breakdown of recrystallisations, partial reduction of molecular chains). In the preparation of the mixture, this corresponds to the mastication process prior to basic and final mixing.

The prior art for the continuous processing of rubber mixtures is the cold feeding of a single-screw extruder having a downstream shaping extrusion head.

Although sufficient plasticising can be induced in the mixture with a single-screw extruder, the possibilities for heat removal are limited by the high channel volume/cooling surface ratio. The achievable throughput is therefore limited by the necessary plasticising capacity and maximum processing temperature.

As an alternative, machine arrangements consisting of rolling mills or an extruder and rolling mill arranged in series with a hot-feed single-screw extruder having an extrusion head are used.

Rolling mills homogenise and plastify the material by dispersive mixing in the roll gap in the form of an elongational flow at gentle temperatures, and by distributive mixing in the roll nip area at the roll crest. The rollers are temperature-controlled and control the temperature of the mixture. The required energy is introduced and adapted to the process or mixture via the residence time in the rolling mill. Such a system is intensive in terms of personnel and costs.

In the processing of plastics, the twin-screw extruder is part of the prior art. In practice, twin-screw extruders are understood as being any conventional plastification devices, extruders and injection-moulding machines that are equipped with two screws located next to one another.

In order to carry out a very wide variety of process tasks, it is known to construct the screws of a twin-screw extruder with different screw portions which consist individually of a succession of screw and kneading members. Such process tasks are, for example, the mixing, melting, degassing and homogenisation of the polymer material with the addition of additives and fillers, while introducing shear forces and maintaining specific temperature profiles that are dependent on the material being processed.

As compared with extruders having only one screw, they have the advantage that the mixing and plastification of the material to be processed are better. If the screws rotate in the same direction, it is not possible to build up pressure for the uniform moulding of a profile. Such systems are therefore used either for preparing the mixture or in combination with gear pumps. A combination of co-rotating twin-screw extruders and a gear pump is known from the direct processing of powdered rubbers. The gear pump is disadvantageous, because it is not self-cleaning.

Rubber webs, so-called feed sheets, are taken in with difficulty by co-rotating systems. It is necessary in such cases to use two screws which rotate in opposite directions. Conical, interengaging screws of equal length are used downstream of the internal mixer or rolling mill. Such systems also do not operate without pulsation or do not build up the necessary extrusion pressure.

A large number of attempts have therefore been made to use, instead of a serial arrangement of a twin screw and a gear pump or a twin screw and a single screw, a twin-screw extruder having two screws of different lengths.

DE 10 2005 014 171 A1 discloses an extruder for processing rubber having two screws of different lengths, the outside diameters of the screws having different diameters in the direction of their longitudinal extension. The two screws can be rotated in opposite directions. Further applications of extruders having two screws of different lengths are known from DE 1 810 061, JP 07-266339 A, JP 05-042580 A and US 2004/0048967 A1.

In the prior art, the two screws rotate at the same screw speed. This means that the residence time in the extruder, and accordingly the shear energy introduced, at a constant speed and throughput can be influenced only by changing the screw geometry or, to a small extent, by the temperature at which the machine is controlled.

The design of the material transfer site at the end of the short screw is critical, because mixture-dependent pressure variations may occur at that point, preventing uniform shaping.

JP 2007-069372 A discloses a twin-screw extruder for processing plastics, in which the screws each have a separate drive. The screws are of equal length, are counter-rotating and can be driven at different speeds. The possibility of different screw speeds is used to influence the processing parameters, such as throughput or melting behaviour. The direction of rotation of the screws is also varied. A disadvantage is that, with two screws of equal length which do not interengage, it is not possible to build up sufficiently uniform, high pressure to achieve uniform moulding by means of a downstream extrusion head.

DE 299 07 974 U1 describes an extrusion device having a short intake roller and a long extruder screw, the intake roller and the extruder screw having separate drive motors. The short intake roller, which is driven separately, does not contribute towards the effective plastification of the material at a gentle temperature, but assists with intake of the material.

### SUMMARY OF THE INVENTION

The object of the invention is to provide a possibility with which conveying and plastification can be achieved without an undesirable increase in temperature. Furthermore, following plastification, it is to be possible to build up pressure with a minimal temperature increase. It is to be possible to control the process in such a manner that different rubber mixtures can be processed on one device without structural alterations or long cleaning times.

According to the invention, therefore, a device, in particular in the form of an extruder, for the processing of polymer materials, in particular rubber, is provided with a first screw and a second screw, in which the second screw is longer than the first screw. Each of the two screws is driven independently of the other and is operated at speeds of rotation and/or in directions of rotation that are independent of one another. It is thereby possible, with a low outlay, to establish the pressure and a pulsation-free throughput in the transition region from the first region to the second region and at the same time meet the desired demands in terms of homogeneity and quality. By adapting the separately adjustable screw speeds to the specific material it is possible, like in a rolling mill, to change the residence time and accordingly the plasticising capacity. The screws can have the same or different diameters, it being possible, for example, for the second screw in a twin-screw region to have a larger diameter than the first screw.

In a particularly advantageous embodiment of the present invention, the device has a first region which includes both screws and is limited by the end of the first screw, and a second region which adjoins the first region and is defined by the portion of the second screw, facing an outlet opening, that projects relative to the first screw. The material is taken in in the first region associated with the twin screw and is then plastified and homogenised. This is followed by a region having a closed housing cylinder at the end of the twin screw. In the further transition region from the twin screw to the single screw, the material pressure can be monitored and, for example, adjusted by changing the speed of the screws. The projecting portion of the second screw, as a single screw, then feeds the material in the direction towards the outlet opening. If the device is connected to an extrusion head, in order thus to permit in particular continuous moulding of the material, the second screw feeds the material against the resulting extrusion resistance.

It is particularly useful if at the same time a direction of rotation and/or speed of rotation for the screws can be established as a function of the measured values detected by means of sensors, in particular the pressure of the material or the temperature, in order thus to achieve control and regulation of the process by means of the direction of rotation and/or speed of rotation on the basis of the detected measured values of the device or the surroundings as well as relevant parameters and also empirical values. The speed of rotation can also be controlled in an oscillating manner.

In principle, a common drive could be designed to transmit variable drive power to the two screws. It is particularly advantageous, on the other hand, if each screw is associated with a separate drive, so that rapid and at the same time independent adjustment of the rotary movement can be achieved.

In another modification of the present invention which is likewise particularly profitable, the two screws in the first region are enclosed by a housing wall which has at least one widening portion transverse to the axis of rotation of the screws. Because the housing wall, which is in particular in the form of a cylinder, is open in portions as a result of this widening portion, which is, for example, radial, a bank forms, for example, on the screw crest in question. A mixing portion as in a rolling mill is accordingly produced. For example, the housing wall can to this end consist of a half-shell, and accordingly half of the screw can be open. The widening portion can also be in the form of a region in which the screws are not enclosed completely by the cylinder wall. Furthermore, the widening portion can also be located laterally next to the screws.

It is particularly advantageous for the volume of the radially widening portion to be adjustable, in order thus to be able to adapt and adjust the mixing chamber volume to the particular process parameters. To that end, the radially widening portion is limited in a simple manner by a movable piston or plunger, which can be operated hydraulically. The residence time of the material in the device is influenced by adjusting the volume. In addition, in the case of an unpressurised process, a vacuum can be applied in this portion in order to remove volatile constituents from the mixture.

Moreover, it is also particularly useful for the device to have in the first region flow restriction members which are in particular adjustable and/or movable in the axial direction, in order thus further to optimise the transport of material.

In an embodiment which is likewise particularly profitable, low pressure, in particular a vacuum, can be applied in a transition region from the first region to the second region, in order thus to allow volatile constituents to be removed from the material. To that end, the device is connected, for example, to a vacuum line or is equipped with a vacuum pump.

It is found to be particularly advantageous for the second screw to have, in the direction of its longitudinal extension, at least two portions of different diameters, in order thus to achieve the necessary conveying capacity.

A further substantial improvement in the device is achieved in that the device has a plurality of mixing members associated with the screws and/or pins arranged in pin planes, by means of which mixing can be optimised in particular as a function of the material in question. The pins can be movable in terms of their position or removable.

In another embodiment which can be used profitably, at least one of the two screws is modular in construction, in particular by means of plug-in connections, so that it can be adapted to the particular conditions of material processing with a comparatively low outlay.

In particular, the second screw has in the second region a radially widening portion which can have a constant, for example conical, form in a transition region between the two regions, that is to say the end portion of the first screw.

In another, particularly practical form of the present invention, the length of the first screw is such that the material is plastified and homogenised within the first region, so that the desired pressure build-up and uniform conveying of the material can advantageously be achieved in the second region.

The screws could be designed in principle to mesh, that is to say to interengage. It is particularly promising, on the other hand, for the two screws to be arranged tangentially or in contact, in order thus to permit independent control of the rotary movement of the independent drives. If required, it is thus also possible to bring one screw to a stop.

The screws are in principle arranged next to or above one another; according to an advantageous embodiment, the screws are arranged parallel to one another, that is to say the screw axes extend in parallel.

Furthermore, it is promising for the device to have an openable cylinder enclosing the screws, in order thus to substantially improve accessibility.

In principle, virtually any desired material can be fed to the device. However, an embodiment in which rubber webs, rubber sheet, rubber bales and/or pellets can be fed as the material to the device is particularly practical. For example, it is also possible to feed rubber webs together with rubber bales. The rubber mixtures can be fed as a finished mixture or in only pre-mixed form.

In addition, in an embodiment in which the device has an inlet for additional materials, further components can be added to the material. These can be, for example, further components and/or recycled material from production.

The aspect is further also achieved by a method for processing polymer materials, in particular rubber, by means of a device having two screws of different lengths, in that each of the two screws is driven independently and operated at speeds of rotation or in directions of rotation that are independent of one another. In this manner it is possible, with a low outlay, to establish the pressure and a pulsation-free throughput in the transition region from the first region to the second region and at the same time meet the desired demands in terms of homogeneity and quality.

### BRIEF DESCRIPTION OF THE DRAWINGS

Various embodiments of the invention are possible. One of those embodiments is shown in the drawings and described hereinbelow, in order to further illustrate the basic principle of the invention. In the drawings:

FIG. 1 is a plan view of a device equipped with two screws of different lengths;

FIG. 2 is a side view of the device shown in FIG. 1.

### DETAILED DESCRIPTION

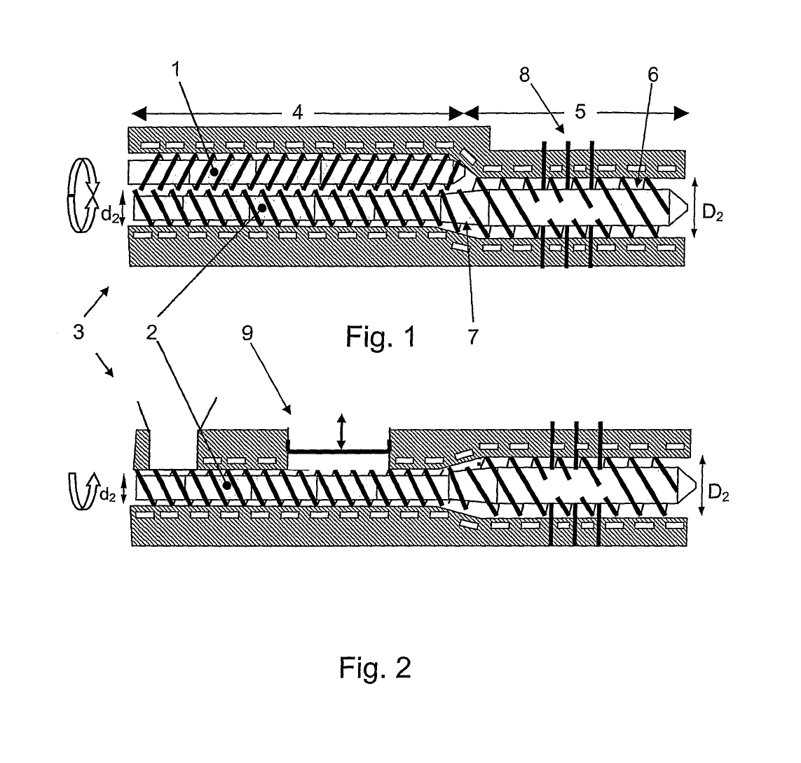

The device 3 according to the invention is described in greater detail hereinbelow with reference to FIGS. 1 and 2, which show, schematically, on the one hand a plan view and on the other hand a side view of the device 3, in the form of an extruder, for processing polymer materials, in particular rubber, equipped with a first screw 1 and a second screw 2. The second screw 2 is longer than the first screw 1. In particular, therefore, the device 3 has a first region 4 which includes both screws 1, 2 and is limited by the end of the first screw 1, and a second region 5 adjoining the first region 4. This second region 5 accordingly corresponds substantially to a portion 6 of the second screw 2 that projects with respect to the first screw 1. In the first region 4, the two screws 1, 2 are located next to one another in the form of a twin screw. They are driven in opposite directions, the screws 1, 2 being arranged next to one another so that they do not mesh but are merely tangential. In the starting region, the extruder is fed with a mixture as the material. Following this starting region, plastification and homogenisation of the material take place, the two screws 1, 2 being enclosed in the first region 4 by a housing wall which is in the form of a cylinder and has at least one radially widening portion 9. The volume of the radially widening portion 9 is fixed or can be adjusted, for example by means of a plunger. Because the housing wall is open in portions, a bank forms on the screw crest. At the same time, a neutral-pressure state is established, in which there occur substantially no shear forces but only expansion forces, and an undesirable introduction of heat is therefore avoided. Alternatively, any desired pressure can be exerted on the mixture by means of the plunger. In an end region of the first screw 1, which is enclosed by a closed housing wall, the material is transferred to the projecting portion 6 of the second screw 2, which is in the form of a single screw and defines the second region 5. In a transition region between the first region 4 and the second region 5, the second screw 2, as a conically widening portion 7, changes from a diameter d₂ in the twin-screw region into a portion having a larger diameter D₂. This pressure in this transition region is monitored by a control means and can be adjusted, for example, by changing the speed of the first screw 1. By selecting appropriate screw geometries, a low pressure, in particular a vacuum, can be applied in the transition region from the first region 4 to the second region 5, in order thus to allow volatile constituents to be removed from the material. In the second region 5, the material is conveyed as uniformly as possible in the direction towards the screw tip, it being possible for pins 8 additionally to be used in that region 5.

1-36. (canceled)

37. A device for processing a polymer material comprising:
a first screw having a first length; and
a second screw having a second length different from the first length, wherein the first screw is configured to be rotated at one of a direction and a speed of rotation that is independent from a respective speed or rotation of the second screw.

38. The device as recited in claim 37, further comprising a first region housing the first and the second screw and limited by a first end of the first screw, and a second region adjoining the first region and defined by a projecting portion of the second screw, the projecting portion facing an outlet opening of the second region.

39. The device as recited in claim 37, wherein the second screw includes at least two portions in a direction of longitudinal extension, the two portions having different diameters.

40. The device as recited in claim 38, wherein the first region includes a housing wall having at least one radially widening portion transverse to an axis of rotation of the first and the second screw, the housing wall partially, but not completely, surrounding at least one of the first and the second screw.

41. The device as recited in claim 37, wherein the first length and a first diameter of the first screw are configured to allow plastification of the polymer material.

42. The device as recited in claim 37, further comprising at least one sensor configured to determine at least one of the speed and the rotation of the first or second screw.

43. The device as recited in claim 42, wherein the at least one sensor is configured to measure one of a pressure and a temperature of the polymer material.

44. The device as recited in claim 37, further comprising a first drive associated with the first screw and a second drive associated with the second screw.

45. The device as recited in claim 40, wherein a volume of the at least one radially widening portion is adjustable.

46. The device as recited in claim in claim 38, wherein the first region includes at least one flow restriction member.

47. The device as recited in claim 38, wherein the first and the second regions define a transition region disposed therebetween, wherein a low pressure is applicable in the transition region.

48. The device as recited in claim 37, further comprising at least one inlet configured to receive an additional material component.

49. The device as recited in claim 37, further comprising a plurality of mixing members associated with the first and the second screws.

50. The device as recited in claim 37, further comprising a plurality of pins associated with the first and the second screws.

51. The device as recited in claim 37, wherein the first and the second screws are disposed to each other.

52. The device as recited in claim 37, wherein the first and the second screws are disposed parallel to one another.

53. The device as recited in claim 37, further comprising an openable cylinder enclosing the first and the second screws.

54. The device as recited in claim 37, wherein the polymer material includes at least one of rubber webs, rubber sheets, rubber bales and pellets feedable to the device.

55. The device as recited in claim 37, wherein the polymer material is feedable into the device continuously.

56. The device as recited in claim 37, wherein at least one of the first and the second screw includes a plurality of separate parts in a modular construction.

57. The device as recited in claim 37, wherein the device is connected to an extrusion head.

58. A method for processing a polymer material comprising:
providing a device, wherein the device includes a first screw having a first length and second screw having a second length;
driving the first screw in at least one of a first speed and first direction of rotation;
driving the second screw in at least one of a second speed and second direction of rotation, wherein the first speed is independent of the second speed and the first direction is independent of the second direction; and
feeding the polymer materials into the device.

59. The method as recited in claim 58, further comprising plastifying the material within a first region of the device.

60. The method as recited in claim 58, further comprising measuring a parameter of the polymer material to produce a measured value, and wherein the driving of the first and second screws is performed using the mesaured value.

61. The method as recited in claim 58, further comprising conveying the polymer materials, and wherein at least one of the conveying and the plastifying the material takes place without an increase in temperature.

62. The method as recited in claim 58, further comprising homogenizing the polymer materials and wherein a pressure build-up takes place following the plastifying and the homogenizing steps.

63. The method as recited in claim 58, further comprising monitoring a pressure in a transition region from a twin-screw region to a single-screw region.

64. The method as recited in claim 58, further comprising adjusting a volume of a radially widening portion of the device.

65. The method as recited in claim 58, further comprising moving flow restriction members in a first region of the device in an axial direction.

66. The method as recited in claim 58, further comprising applying a low pressure to a transition region from a first region to a second region of the device.

67. The method as recited in claim 58, wherein the polymer material include at least one of rubber webs, rubber bales, rubber sheets and pellets.

68. The method as recited in claim 58, wherein the feeding step includes feeding the material continuously.

69. The method as recited in claim 58, further comprising adapting at least one of a screw length and a screw diameter to a property of the polymer material.

70. The method as recited in claim 58, wherein the polymer materials are not in a form of a finished mixture.

71. The method as recited in claim 58, wherein the feeding step includes feeding different material components to the device at at least one inlet.
